(19) United States
(12) Patent Application Publication
(10) Pub. No.: US 2021/0223742 A1
(43) Pub. Date: Jul. 22, 2021

(54) Electronic Watch And Control Method Of Electronic Watch

(71) Applicant: Seiko Epson Corporation, Tokyo (JP)

(72) Inventor: Toshikazu AKIYAMA, Matsumoto (JP)

(21) Appl. No.: 17/152,829

(22) Filed: Jan. 20, 2021

(30) Foreign Application Priority Data
Jan. 21, 2020 (JP) 2020-007500

(51) Int. Cl. G04B 19/04; G04B 47/06; G04C 3/14

(52) U.S. Cl. CPC G04B 19/04; G04C 3/14; G04B 47/06

(57) ABSTRACT

An electronic watch includes a hand, a driving mechanism that drives the hand, a hand position detection mechanism that detects that the hand is at a reference position, and a controller that, when a system reset is performed, performs first control processing of moving, by the driving mechanism, the hand in a first direction by a first number of steps, and subsequently performs second control processing of performing, by the hand position detection mechanism, a detection operation every time moving the hand in a second direction that is a direction opposite to the first direction.

The present application is based on, and claims priority from JP Application Serial Number 2020-007500, filed Jan. 21, 2020, the disclosure of which is hereby incorporated by reference herein in its entirety.

### BACKGROUND

### 1. Technical Field

The present disclosure relates to an electronic watch and a control method of an electronic watch.

### 2. Related Art

In JP-A-2016-8949, it is disclosed that, in a process of assembling an electronic watch in a factory, hand position detection processing is performed when each of toothed gears is moved to a reference position for attaching a hand to each train wheel, or when a system reset is performed.

In other words, when the hand position detection processing is started for hour and minute hands, which are moved by a single hour/minute motor in an interlocked manner, first, the hour/minute motor is driven by one pulse, and polarities of rotors are aligned. Then, by alternately performing an operation of an optical sensor, which detects hand positions of the hour and minute hands, and driving of the hour/minute motor, the hand position detection processing for the hour and minute hands is performed.

In a manufacturing process of an electronic watch, the system reset may be performed a plurality of times, such as when attaching the hand or when turning on a battery. In other words, in response to the system resets, the hand position detection processing is performed the plurality of times. In this case, for example, in the motor for driving the hour and minute hands in the interlocked manner, when the hand position detection processing is performed when phases of hour and minute train wheels are aligned, that is, when the hour and minute hands are aligned at a 00:00 position, which is a reference position thereof, as described above, since the hand position detection processing is performed after the hour/minute motor is driven by one pulse in order to align the polarities of the rotors, it is necessary to turn the hour and minute hands by one full rotation, which creates a problem in that it takes time to perform the hand position detection processing.

### SUMMARY

An electronic watch according to the present disclosure includes a hand, a driving mechanism configured to drive the hand, a hand position detection mechanism configured to detect that the hand is at a reference position, and a controller configured to, when a system reset is performed, perform first control processing of moving, by the driving mechanism, the hand in a first direction by a first number of steps, and subsequently perform second control processing of performing, by the hand position detection mechanism, a detection operation every time moving the hand in a second direction that is a direction opposite to the first direction.

In a control method of an electronic watch according to the present disclosure, the electronic watch includes a hand, a driving mechanism configured to drive the hand, and a hand position detection mechanism configured to detect that the hand is at a reference position. The control method includes performing, when a system reset is performed, first control processing of moving, by the driving mechanism, the hand in a first direction by a first number of steps, and subsequently performing second control processing of performing, by the hand position detection mechanism, a detection operation every time moving the hand in a second direction that is a direction opposite to the first direction.

### BRIEF DESCRIPTION OF THE DRAWINGS

FIG. 1 is a perspective view illustrating an electronic watch according to a first embodiment.

FIG. 2 is an exploded perspective view of an hour/minute hand drive mechanism of the electronic watch.

FIG. 3 is a block diagram illustrating a hand position detection device of the electronic watch.

FIG. 4 is a flowchart illustrating hand position detection processing according to the first embodiment.

FIG. 5 is a flowchart illustrating hand position detection processing according to a second embodiment.

FIG. 6 is a flowchart illustrating hand position detection processing according to a third embodiment.

### DESCRIPTION OF EXEMPLARY EMBODIMENTS

### First Embodiment

A first embodiment of an electronic watch 1 will be described below with reference to the drawings.

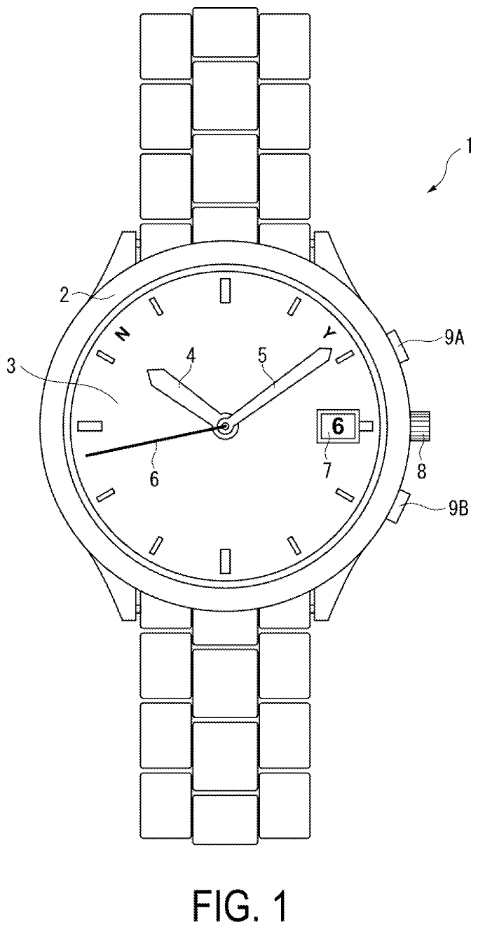

FIG. 1 is a schematic front view of the electronic watch 1. The electronic watch 1 includes a case 2, a dial 3 disposed inside the case 2, an hour hand 4, a minute hand 5, and a seconds hand 6 that are respectively attached to three hand shafts provided at a planar center position of the dial 3, a date indicator 7, a crown 8, an A button 9A, and a B button 9B.

The electronic watch 1 is an electronic watch with a hand position detection function that corrects a display time by receiving satellite signals transmitted from a location information satellite such as a GPS satellite, or radio waves such as standard radio waves, from which time information can be acquired.

Thus, although not illustrated, the electronic watch 1 includes an antenna and a reception circuit for receiving the radio waves, drive mechanisms for driving the hour hand 4, the minute hand 5, the seconds hand 6, and the date indicator 7, a hand position detection mechanism, a controller 60 that controls driving of the drive mechanisms and the hand position detection mechanism, a power source such as a secondary battery, and the like. As will be described below, the controller 60 includes a rotation controller 61 that controls the driving of the drive mechanisms, and a detection controller 62 that controls the driving of the hand position detection mechanism.

The drive mechanisms include a seconds hand drive mechanism that drives the seconds hand 6, an hour/minute hand drive mechanism 10 that drives the hour hand 4 and the minute hand 5, and a date indicator drive mechanism that drives the date indicator 7. Each of the drive mechanisms includes a motor that is drive-controlled by motor pulses. A seconds motor 70, which drives the seconds hand 6, moves the seconds hand 6 for one full rotation by 60 pulse inputs, and an hour/minute motor 20, which drives the hour hand 4 and the minute hand 5, moves the minute hand 5 for 12 full rotations and the hour hand 4 for one full rotation by 8640 pulse inputs.

The hand position detection mechanism includes a seconds hand position detection mechanism that detects that the seconds hand 6 is at a 0 second position, which is a reference position thereof, and an hour/minute hand position detection mechanism that detects that the hour hand 4 and the minute hand 5 are at a 00:00 position, which is the reference position thereof. A position detection mechanism for the date indicator 7 is not provided.

When the frequency of each of the motor drive pulses at the time of the hand position detection is 20 Hz, a time period required to drive the seconds hand 6 for one full rotation, that is, a maximum time period required to detect the hand position of the seconds hand 6 is 1/20×60=3 seconds. Similarly, a time period required to drive the hour hand 4 for one full rotation and the minute hand 5 for 12 full rotations, that is, a maximum time period required to detect the hand positions of the hour hand 4 and the minute hand 5 is 1/20×8640=432 seconds=7.2 minutes.

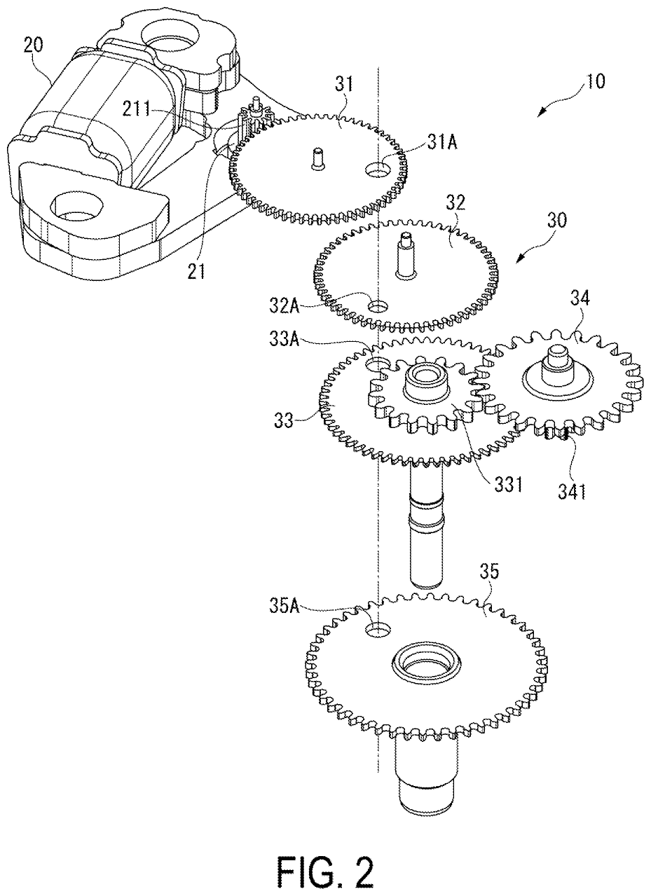

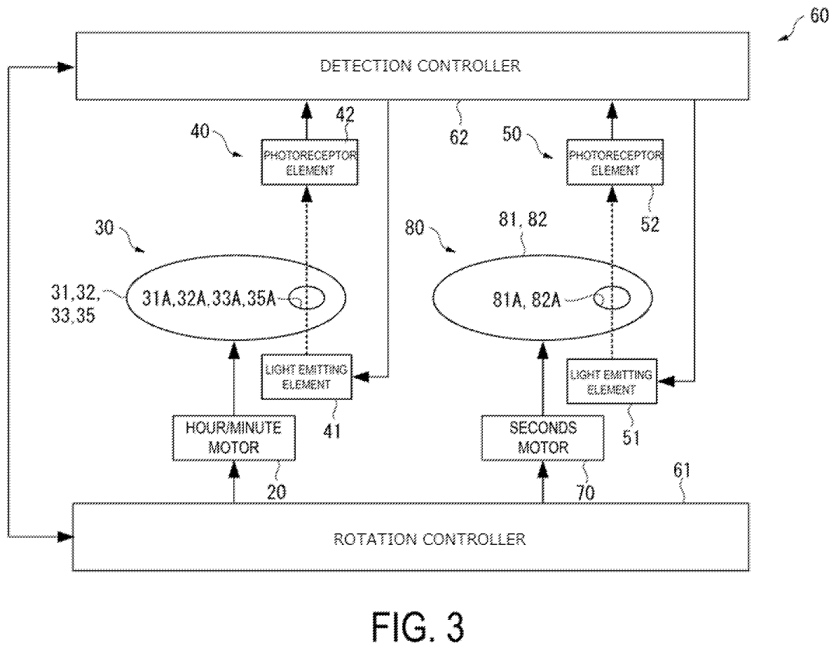

A specific example of the hour/minute hand drive mechanism and the hour/minute hand position detection mechanism will be described below with reference to FIG. 2 and FIG. 3.

### Hour/minute Hand Drive Mechanism

As illustrated in FIG. 2, the hour/minute hand drive mechanism 10 includes the hour/minute motor 20, which is a driving device, an hour/minute hand train wheel 30 that transmits a driving force from the hour/minute motor 20, and the rotation controller 61 (see FIG. 3) that controls driving of the hour/minute motor 20. Note that FIG. 2 is an exploded perspective view of the hour/minute hand drive mechanism 10 as viewed from the back side of the electronic watch 1.

The hour/minute motor 20 is configured by a generic stepper motor including a rotor 21.

The hour/minute hand train wheel 30 includes a fifth wheel and pinion 31 that engages with a rotor pinion 211 integrally formed in the rotor 21 of the hour/minute motor 20, a third wheel and pinion 32 that engages with a pinion (not illustrated) of the fifth wheel and pinion 31, a center wheel and pinion 33 that engages with a pinion (not illustrated) of the third wheel and pinion 32, a minute wheel 34 that engages with a pinion 331 of the center wheel and pinion 33, and an hour wheel 35 that engages with a pinion 341 of the minute wheel 34.

The center wheel and pinion 33 and the hour wheel 35 are disposed coaxially with a seconds wheel and pinion (not illustrated) to which the seconds hand 6 is attached. Further, the minute hand 5 is attached to the center wheel and pinion 33, and the hour hand 4 is attached to the hour wheel 35.

The rotation controller 61 outputs a drive pulse to the hour/minute motor 20 and controls rotary driving of the hour/minute motor 20. The rotation controller 61 of the present embodiment is configured to be able to switch the frequency of the drive pulse in two stages.

Here, a reduction ratio of the hour/minute hand train wheel 30 of the present embodiment is set such that when one pulse is input to the hour/minute motor 20, the minute hand 5 is moved by 1/12 minute. Thus, during a normal hand operation, 12 pulses causes the minute hand 5 to be moved by one minute (60 seconds), and thus the rotation controller 61 sets the frequency of the drive pulse to 1/5 Hz.

On the other hand, at the time of the hand position detection, the rotation controller 61 sets the frequency of the drive pulse to 20 Hz such that fast-forwarding is possible.

When the hour/minute motor 20 is driven, the rotor 21 is rotated, and this rotary motion is sequentially transmitted to the rotor pinion 211, the fifth wheel and pinion 31, the third wheel and pinion 32, and the center wheel and pinion 33 in this order, while being decelerated using an appropriate reduction ratio at each stage. Then, when the hour/minute motor 20 is driven at the frequency applied at the time of the normal hand operation, the center wheel and pinion 33 and the minute hand 5 rotate at a cycle (speed) that causes the center wheel and pinion 33 and the minute hand 5 to rotate one full rotation every one hour. Further, the rotary motion of the center wheel and pinion 33 is sequentially transmitted to the minute wheel 34 and the hour wheel 35 in this order, while being decelerated using an appropriate reduction ratio at each stage, and the hour wheel 35 and the hour hand 4 rotate at a cycle (speed) that causes the hour wheel 35 and the hour hand 4 to rotate one full rotation every 12 hours.

Hour/minute Hand Position Detection Mechanism Next, the hand position detection mechanism for the hour hand 4 and the minute hand 5 will be described while also referring to FIG. 3.

As illustrated in FIG. 3, in the present embodiment, a hour/minute hand optical sensor 40 and the detection controller 62 are provided as the hand position detection mechanism. The hour/minute hand optical sensor 40 includes a light emitting element 41 and a photoreceptor element 42, and is controlled by the detection controller 62.

The hour/minute hand optical sensor 40 is configured to detect that the hour hand 4 and the minute hand 5, which are driven by the hour/minute motor 20 and the hour/minute hand train wheel 30, are positioned at the reference position, specifically, a 12 o'clock position (a position indicating 00:00 or 12:00).

Next, each of optical sensors will be described below in detail.

### Hour/minute Hand Optical Sensor

As illustrated in FIG. 2 and FIG. 3, detection holes 31A, 32A, 33A, and 35A are formed in the fifth wheel and pinion 31, the third wheel and pinion 32, the center wheel and pinion 33, and the hour wheel 35, respectively.

Then, the detection holes 31A, 32A, 33A, and 35A are set so as to overlap with each other at a second reference position, when the hour hand 4 and the minute hand 5 are disposed at the 12 o'clock position. The transmissive-type hour/minute hand optical sensor 40 is provided at this second reference position. The hour/minute hand optical sensor 40 includes the light emitting element 41 and the photoreceptor element 42, and these light emitting element 41 and photoreceptor element 42 are provided on either side, in the thickness direction, of the fifth wheel and pinion 31, the third wheel and pinion 32, the center wheel and pinion 33, the minute wheel 34, and the hour wheel 35, and are disposed facing each other with the five wheels 31, 32, 33, 34, and 35 interposed therebetween.

Although not illustrated, the light emitting device 41 is mounted on a circuit block disposed on the front side of a main plate. Further, the photoreceptor element 42 is mounted on a circuit block disposed further to a case back side than the back plate. The five wheels 31, 32, 33, 34, and 35 are disposed between the light emitting element 41 and the photoreceptor element 42.

Note that when the main plate and a train wheel bridge are disposed between the light emitting element 41 and the photoreceptor element 42, a light transmission hole is provided in each of the main plate and the train wheel bridge so as not to inhibit the light transmission of the hour/minute hand optical sensor 40.

As will be described below, the detection controller 62 operates the hour/minute hand optical sensor 40 every time the hour/minute motor 20 is driven one step in an hour/minute hand position detection process. Then, when detection light is emitted from the light emitting element 41 of the hour/minute hand optical sensor 40 in a state in which the detection holes 31A, 32A, 33A, and 35A are aligned as a result of the fifth wheel and pinion 31, the third wheel and pinion 32, the center wheel and pinion 33, and the hour wheel 35 rotating, the detection light passes through the detection holes 31A, 32A, 33A, and 35A and is received by the photoreceptor element 42. Thus, it is detected that the hour hand 4 and the minute hand 5 are disposed at the 12 o'clock position, that is, are in a state of being at the reference position.

Seconds Hand Drive Mechanism and Seconds Hand Position Detection Mechanism

As illustrated in FIG. 3, the seconds hand drive mechanism includes the seconds motor 70, a seconds hand train wheel 80 that transmits a driving force of the seconds motor 70, and the rotation controller 61 that controls driving of the seconds motor 70. The seconds motor 70 is a stepper motor similar to the hour/minute motor 20.

The seconds hand train wheel 80 includes a plurality of toothed gears, and in at least toothed gears 81 and 82, detection holes 81A and 82A are formed so as to overlap with each other in the axial direction of the toothed gears 81 and 82 when the seconds hand 6 is moved to the 0 second position, which is the reference position thereof.

The seconds hand position detection mechanism is provided with a seconds hand optical sensor 50 and the detection controller 62.

Similarly to the hour/minute hand optical sensor 40, the seconds hand optical sensor 50 includes a light emitting element 51 and a photoreceptor element 52 and is controlled by the detection controller 62.

The seconds hand optical sensor 50 detects that the seconds hand 6, which is driven by the seconds motor 70 and the seconds hand train wheel 80, is positioned at the reference position, specifically at the 0 second position. Since the seconds hand optical sensor 50 is similar to the hour/minute hand optical sensor 40, a description thereof is omitted.

As will be described below, the detection controller 62 operates the seconds hand optical sensor 50 every time the seconds motor 70 is driven one step in a seconds hand position detection process. Then, when detection light is emitted from the light emitting element 51 of the seconds hand optical sensor 50 in a state in which the detection holes 81A and 82A are aligned as a result of the toothed gears 81 and 82 rotating, the detection light passes through the detection holes 81A and 82A and is received by the photoreceptor element 52. Thus, it is detected that the seconds hand 6 is disposed at the 0 second position, that is, is in a state of being at the reference position.

Calendar Drive Mechanism

Although not illustrated, a calendar drive mechanism includes a date motor, a date indicator train wheel that transmits a driving force of the date motor, and a rotation controller that controls driving of the date motor. Note that the electronic watch 1 is not provided with a detection mechanism for detecting a reference position of the date indicator 7.

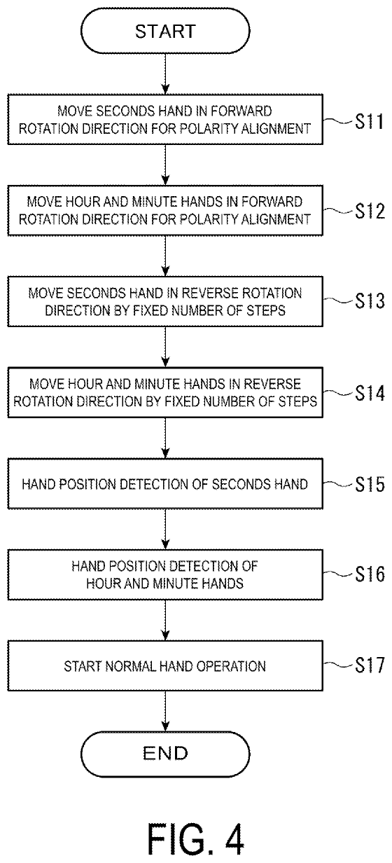

Next, a control flow of the controller 60 at a time of the system reset according to the present embodiment will be described with reference to FIG. 4.

The system reset is performed when a predetermined condition is met. Examples of the predetermined condition include an operation of the button 9A, the button 9B, or the crown 8 by an operator, an input into a system reset terminal that is exposed by the case back being opened, and turning on a battery.

When the system reset occurs, the controller 60 performs a forward rotation operation for aligning a polarity of the rotor 21 of the hour/minute motor 20 and the seconds motor 70 with a polarity of the drive pulse output from the rotation controller 61, that is, with a direction of a drive current flowing through a motor coil. Note that in the present embodiment, when the electronic watch 1 is viewed from the front, a direction in which each of the hands is rotated in the clockwise direction is referred to as a forward rotation direction, and a direction in which each of the hands is rotated in the counterclockwise direction is referred to as a reverse rotation direction.

Specifically, first, in order to align the polarity of the rotor of the second motor 70 with the polarity of the drive pulse, the controller 60 executes step S11 at which two drive pulses are output to drive the seconds motor 70, that is, to move the seconds hand 6 in the forward rotation direction.

When the two drive pulses are output in a state in which the polarities are aligned, the seconds hand 6 is moved two steps, that is, two seconds. On the other hand, when the two drive pulses are output in a state in which the polarities are not aligned, the first drive pulse does not cause the seconds motor 70 to move, and thus, the seconds hand 6 is moved one step, that is, one second.

Thus, when the two drive pulses are output, the seconds hand 6 is moved one step or two steps, but in either case, a state is obtained in which the polarities are aligned.

Next, in order to align the polarity of the hour/minute motor 20, the controller 60 executes step S12 at which two drive pulses are output to drive the hour/minute motor 20, that is, to move the hour hand 4 and the minute hand 5 in the forward rotation direction. Similarly to the seconds motor 70, when the two drive pulses are output to the hour/minute motor 20, the hour hand 4 and the minute hand 5 are moved one step or two steps, and in either case, a state is obtained in which the polarities are aligned.

Next, in order to eliminate backlash of the hour/minute hand train wheel 30 and the seconds hand train wheel 80 and to end the hand position detection within a minimum time period, the seconds hand 6, the hour hand 4, and the minute hand 5 are moved in the reverse rotation direction for a fixed number of steps. A number of pulses required during this reverse rotation is a number greater than the sum of a “number of pulses for the polarity alignment” and a “number of pulses required to eliminate the backlash”.

Here, the fixed number of pulses for the reverse rotation is different depending on the number of pulses required to eliminate the backlash. When the number of pulses required to eliminate the backlash is N pulses, it is sufficient that the fixed number of pulses for the reverse rotation be (N+2) or more, which is the sum of the two pulses required for the forward hand operation to align the polarities, and the N pulses. Thus, the fixed number of pulses for the reverse rotation may be, for example, 3 when N=1, 4 when N=2, and 122 when N=120.

The number of pulses required to eliminate the backlash varies depending on a structure of the train wheel and the like, but it takes approximately 10 minutes with the minute hand 5. Thus, when 12 pulses are required to move the minute hand 5 by one minute, the number of pulses is 120.

After the processing at step S12, the controller 60 executes step S13 at which the seconds hand 6 is moved in the reverse rotation direction for the fixed number of steps. Next, the controller 60 executes step S14 at which the hour hand 4 and the minute hand 5 are moved in the reverse rotation direction for the fixed number of steps.

When the number of pulses for the reverse rotation is 3, when step S13 and step S14 are performed, each of the hands is moved to a position that is one step or two steps in the reverse rotation direction, with respect to an initial position obtained before the execution of step S11. In other words, when the hand is moved two steps in the forward rotation direction by the two pulses for the polarity alignment, the hand is moved to the position that is one step in the reverse rotation direction, with respect to the initial position, as a result of the three reverse rotation pulses. Further, when the hand is moved one step in the forward rotation direction by the two pulses for the polarity alignment, the hand is moved to a position that is two steps in the reverse rotation direction, with respect to the initial position, as a result of the three reverse rotation pulses.

The processing at step S13 and step S14 is first control processing. Thus, the reverse rotation direction is an example of a first direction, and the fixed number of steps is an example of a first number of steps.

After the processing at step S14, the controller 60 executes step S15, which is the seconds hand position detection process for detecting the hand position of the seconds hand 6. In the seconds hand position detection process, as described above, the rotation controller 61 causes the seconds hand 6 to be driven one step at a time in the forward rotation direction, and every time the seconds hand 6 is driven, the seconds hand optical sensor 50 is operated to detect whether or not the seconds hand 6 is at the 0 second position, which is the reference position thereof.

When it is detected that the seconds hand 6 has moved to the 0 second position at step S15, the controller 60 executes step S16, which is the hour/minute hand position detection process for detecting the hand positions of the hour hand 4 and the minute hand 5. In the hour/minute hand position detection process, as described above, the rotation controller 61 causes the hour hand 4 and the minute hand 5 to be driven one step at a time, and every time the hour hand 4 and the minute hand 5 are driven, the hour/minute hand optical sensor 40 is operated to detect whether or not the hour hand 4 and the minute hand 5 are at the 00:00 position, which is the reference position thereof.

The processing at step S15 and step S16 is second control processing. Thus, the forward rotation direction is an example of a second direction.

When it is detected that the hour hand 4 and the minute hand 5 have moved to the 00:00 position at step S16, the controller 60 terminates the hand position detection processing at the time of the system reset, and executes step S17 to start the normal hand operation.

In a manufacturing process of the electronic watch 1, the system reset is performed a plurality of times. For example, before the hands are attached to the hand shafts, the system reset is performed to obtain a state in which the backlash, in the forward rotation direction, of each of the train wheels 30 and 80 is eliminated. By attaching the hands to the hand shafts in this state, attachment accuracy of the hands can be improved. Then, after the attachment of the hands, the system reset is performed again to confirm whether each of the hands is attached so as to indicate the reference position.

When the system reset is performed the plurality of times in this manner, at times of the second and subsequent system resets, the processing illustrated in FIG. 4 may be performed in a state in which each of the hands is stopped at the reference position. In this case, as described above, at the point in time at which each of the hands is moved by the fixed number of steps in the reverse rotation direction at step S13 and step S14, each of the hands is at a position moved by N steps or N+1 steps in the reverse rotation direction, with respect to the reference position. Thus, in the hand position detection process at step S15 and step S16, each of the hands can be moved to the reference position simply by being moved by N steps or N+1 steps required to eliminate the backlash, and then, the hand position detection process can be terminated. In this way, a time required for the hand position detection process can also be shortened.

Note that when the system reset is performed, positional information of the hands held by the controller 60 is initialized. Specifically, the controller 60 initializes a value of a hand position counter, which counts an indication position of the hand, to a value indicating the reference position, that is, to Day 1 00:00:00.

Further, the first control processing and the second control processing illustrated in FIG. 4 are performed at the time of the system reset, but are not performed during the normal hand operation. The reason why each of the control processing is not performed during the normal hand operation is as described below. Specifically, during the normal hand operation, the hand positions are normally aligned, and a frequency of the hand positions being misaligned is low. For this reason, it is not necessary to perform the first control processing and the second control processing during the normal hand operation, and on the contrary, if the first and second control processing are performed during the normal hand operation, the hand movement looks strange to the user.

Further, the present embodiment is effective in shortening the time required for the hand position detection when the phases are aligned. However, if the phases are misaligned during the normal hand operation, the hand operation in the reverse rotation direction is not necessarily an optimum operation in terms of shortening the time. This is yet another reason for the above-described configuration.

Effects of First Embodiment

According to the present embodiment, the electronic watch 1 is provided with the hour hand 4, the minute hand 5, and the seconds hand 6, which are the hands, the hour/minute motor 20 and the seconds motor 70, which are driving mechanisms for driving the hands, the hand position detection mechanisms that detect that the hands are at the reference positions, and the controller 60 that performs the first control processing at step S13 and step S14 at which, when the system reset is performed, the driving mechanisms are caused to move the hands in the first direction, which is the reverse rotation direction, by the fixed number of steps, and subsequently performs the second control processing at step S15 and step S16 at which the detection operations are performed by the hand position detection mechanisms every time moving the hands in the second direction, which is the forward rotation direction.

Thus, when the system reset is performed in a state in which each of the hands is at the reference position, by setting the fixed number of the first control processing based on the number of pulses required to move the hands in the reverse rotation direction with respect to the reference positions and required to eliminate the backlash, at the time of the second control processing, each of the hands can be moved to the reference position with a minimum hand operation in a state in which the backlash is eliminated. Thus, when the system reset is performed the plurality of times in the manufacturing process of the electronic watch 1, the hand position detection time can be shortened at least at the times of the second and subsequent system resets, that is, at the times when the system reset is performed in the state in which each of the hands are at the reference position.

Further, when the processing at the time of the system reset is performed before attaching the hands, the backlash of the hour/minute hand train wheel 30 and the seconds hand train wheel 80 can be eliminated to the same side, that is, to the forward rotation side. When the hands are attached in this state, the attachment accuracy of the hands can be improved. Furthermore, when the processing at the time of the system reset is performed in a state in which the hands are attached, an indicator indication accuracy of each of the hands, which have been moved to the reference positions by the hand position detection processing, can also be improved.

Then, the processing at the time of the system reset can also perform the processing for attaching the hands, namely, can move the hands to the reference positions in a state in which the backlash of each of the train wheels 30 and 80 is eliminated to the forward rotation side. Thus, there is no need to separately provide a dedicated mode for attaching the hands, and the processing at the time of the system reset can be also used for that purpose.

Since, after the system reset, the controller 60 initially moves the hands in the forward rotation direction to perform the polarity alignment, the polarity alignment can be performed properly even in a model in which the polarity alignment needs to be performed by moving the hands in the forward rotation direction.

### Second Embodiment

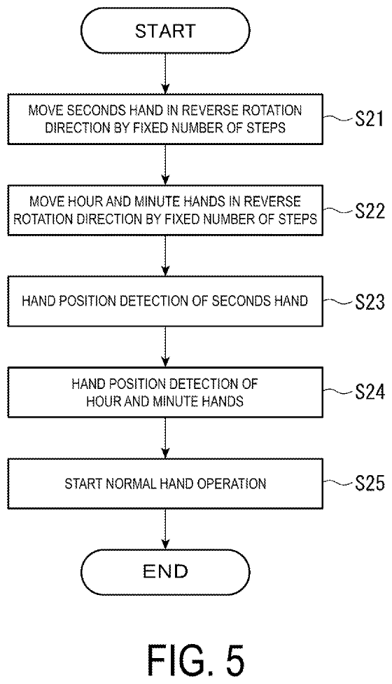

A second embodiment differs from the first embodiment only in the control flow of the controller 60 at the time of the system reset. Thus, the second embodiment will be described below with reference to a control flow illustrated in FIG. 5.

In the second embodiment, the movement of the hands in the forward rotation direction for the polarity alignment is omitted, by performing the polarity alignment with moving the hands in the first direction, which is the reverse rotation direction, in a case of a model in which the polarity alignment can be performed by moving the hands in the reverse rotation direction without any problem.

Thus, the controller 60 does not perform the processing at step S11 and step S12 of the first embodiment, and at the time of the system reset, the controller 60 first executes step S21, which is the first control processing for moving the seconds hand 6 in the reverse rotation direction by the fixed number of steps, that is, the first number of steps.

Next, the controller 60 executes step S22, which is the first control processing for moving the hour hand 4 and the minute hand 5 in the reverse rotation direction by the fixed number of steps, that is, the first number of steps.

Here, when the number of pulses, in the forward rotation direction, required to eliminate the backlash is N steps, it is sufficient that the fixed number of steps, that is, the first number of steps at step S21 and step S22 be at least (N+1) steps, which is obtained by adding one step to the N steps as compensation for a case in which, due to misalignment of the polarities, the hands are not moved by the first step in the reverse rotation direction. Therefore, when N=1, it is sufficient that the hands be moved by two steps in the reverse rotation direction, and when N=2, it is sufficient that the hands be moved by three steps in the reverse rotation direction.

After the processing at step S22, the controller 60 executes step S23, which is the seconds hand position detection process for detecting the hand position of the seconds hand 6. Since step S23 is the second control processing identical to step S14 of the first embodiment, a description thereof is omitted.

When it is detected that the seconds hand 6 has moved to the 0 second position at step S22, the controller 60 executes step S24, which is the hour/minute hand position detection process for detecting the hand positions of the hour hand 4 and the minute hand 5. Since step S24 is the second control processing identical to step S15 of the first embodiment, a description thereof is omitted.

When it is detected that the hour hand 4 and the minute hand 5 have moved to the 00:00 position at step S24, the controller 60 terminates the hand position detection process at the time of the system reset, and executes step S25 to start the normal hand operation.

Effects of Second Embodiment

According to the second embodiment, in the same manner as in the first embodiment, since step S21 and step S22, which are the first control processing, and step S23 and step S24, which are the second control processing, are performed, when the system reset is performed the plurality of times in the manufacturing process of the electronic watch 1, at least at the times of the second and subsequent system resets, namely, when the system reset is performed in the state in which each of the hands is positioned at the reference position, the hand position detection time can be shortened.

Further, when the processing at the time of the system reset is performed before attaching the hands, the backlash of the hour/minute hand train wheel 30 and the seconds hand train wheel 80 can be eliminated to the same side, that is, to the forward rotation side, and it is thus possible to improve the attachment accuracy and the indication accuracy of the hands.

Furthermore, when moving the hands by the fixed number of steps in the reverse rotation direction, that is, when moving the hands by the first number of steps in the first direction, the polarity alignment can also be performed, so an operation of moving the hands in the forward rotation direction for the polarity alignment can be omitted. As a result, a number of hand movements can be reduced compared to the first embodiment, and the hand position detection time can be further shortened.

### Third Embodiment

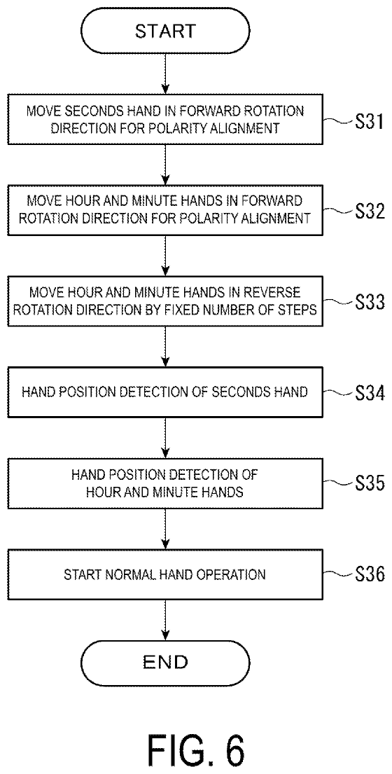

A third embodiment differs from the first and second embodiments only in the control flow of the controller 60 at the time of the system reset. Thus, the third embodiment will be described below with reference to a control flow illustrated in FIG. 6.

In the third embodiment, the same processing as in the first embodiment is performed with respect to the hand for which a maximum time required for the hand position detection processing exceeds a threshold value, and, with respect to the hand for which the maximum time is the threshold value or less, the second control processing, that is, the hand position detection processing is performed without performing the first control processing.

The threshold value can be set as appropriate, and is three seconds, for example. Thus, as described in the first embodiment, the seconds hand 6 for which the maximum time of the hand position detection processing is three seconds is the hand having the maximum time of the threshold value or less, and the hour hand 4 and the minute hand 5 for which the maximum time is approximately seven minutes are the hands having the maximum time exceeding the threshold value. Note that whether or not the first control processing is performed may be set for each of the hands in advance based on the threshold value, when a designer determines the driving speed of each of the hands.

Thus, when the system reset occurs, in the same manner as at step S11 and step S12 of the first embodiment, the controller 60 performs processing at step S31 at which the seconds hand 6 is moved by two steps in the forward rotation direction for the polarity alignment, and executes step S32 at which the hour hand 4 and the minute hand 5 are moved by two steps in the forward rotation direction.

Next, the controller 60 does not perform step S13 of the first embodiment, and executes step S33, which is the first control processing identical to step S14 of the first embodiment, at which the hour hand 4 and the minute hand 5 are moved in the reverse rotation direction by the fixed number of steps.

After the processing at step S33, the controller 60 executes step S34, which is the seconds hand position detection process for detecting the hand position of the seconds hand 6. Since step S34 is the second control processing identical to step S15 of the first embodiment, a description thereof is omitted. At this time, since the first control processing is not performed with respect to the seconds hand 6, that is, since the seconds hand 6 is not moved by the fixed number of steps in the reverse rotation direction, for example, when the system reset is performed while the seconds hand 6 is at the 0 second position, which is the reference position, the seconds hand 6 is moved to a one second position or to a two seconds position at step S31. Thus, in order to move the seconds hand 6 to the reference position at step S34, the seconds hand 6 needs to be moved by an amount corresponding to 58 seconds or 59 seconds. Thus, it takes more time to perform the hand position detection processing of the seconds hand 6 compared to the first and second embodiments. However, since the actual time required is three seconds or less, this is an acceptable amount of time in the manufacturing process.

When it is detected that the seconds hand 6 has moved to the 0 second position at step S34, the controller 60 executes step S35, which is the hour/minute hand position detection process for detecting the hand positions of the hour hand 4 and the minute hand 5. Since step S25 is the second control processing identical to step S16 of the first embodiment, a description thereof is omitted.

When it is detected that the hour hand 4 and the minute hand 5 have moved to the 00:00 position at step S35, the controller 60 terminates the hand position detection processing at the time of the system reset, and executes step S36 to start the normal hand operation.

Effects of Third Embodiment

According to the third embodiment, in the same manner as in the first embodiment, since step S33, which is the first control processing, and step S35, which is the second control processing, are performed, when the system reset is performed the plurality of times in the manufacturing process of the electronic watch 1, at least at the times of the second and subsequent system resets, namely, when the system reset is performed in the state in which the hour hand 4 and the minute hand 5 are positioned at the reference position, the hand position detection time can be shortened. Note that although the first control processing and the second control processing are performed with respect to the hour hand 4 and the minute hand 5, when the maximum time required for the hand position detection processing of the hour hand 4 or the minute hand 5 exceeds the threshold value, the first control processing and the second control processing may be performed with respect to only one of the hour hand 4 and the minute hand 5. Further, when the processing at the time of the system reset is performed before attaching the hands, the backlash of the hour/minute hand train wheel 30 can be eliminated to the same side, that is, to the forward rotation side, and the attachment accuracy and the indication accuracy of the hour hand 4 and the minute hand 5 can also be improved.

Further, also with respect to the seconds hand 6, the backlash of the seconds hand train wheel 80 can be eliminated to the forward rotation side, and thus the attachment accuracy and the indication accuracy of the seconds hand 6 can also be improved. Further, since the seconds hand 6 is always rotated by one full rotation, it is possible to clearly indicate that the system reset has been performed without significantly increasing the time required for the hand position detection processing compared to the first and second embodiments. Further, a motor for moving the seconds hand 6 only in the forward rotation direction can also be used as the seconds motor 70.

### Other Exemplary Embodiments

Note that the present disclosure is not limited to each of the embodiments described above, and variations, modifications, and the like within the scope in which the object of the present disclosure can be achieved are included in the present disclosure.

For example, since the hour hand 4 and the minute hand 5, and the seconds hand 6 can be independently driven by the hour/minute motor 20 and the seconds motor 70, the hour hand 4 and the minute hand 5, and the seconds hand 6 may be simultaneously driven to perform the polarity alignment. Similarly, the processing for moving the hour hand 4 and the minute hand 5, and the processing for moving the seconds hand 6 in the reverse rotation direction by the fixed number of steps may be simultaneously performed, or the hand position detection processing of the hour hand 4 and the minute hand 5, and the hand position detection processing of the seconds hand 6 may be simultaneously performed. By performing the above-described processing simultaneously, a time from the system reset to the normal hand operation can be shortened.

The hand position detection mechanism is not limited to the hour/minute hand optical sensor 40 and the seconds hand optical sensor 50, and other mechanisms, such as a mechanism for detecting the hand position by magnetic field detection, may be used.

A hand whose hand position is detected at the time of the system reset may be other than the hour hand 4, the minute hand 5, and the seconds hand 6. For example, the hand may be a hand indicating an operation mode of the electronic watch 1, a hand indicating a day of the week, and the like, or may be any hand as long as it can be subject to the hand position detection. Further, in a case in which a mechanism for detecting the position of the date indicator 7 is provided, the position of the date indicator 7 may also be detected at the time of the system reset.

In the above-described embodiments, the hour hand 4 and the minute hand 5 are driven by the hour/minute motor 20 and the seconds hand 6 is driven by the seconds motor 70, but a combination of the motor and the hand is not limited to those described above in the embodiments. For example, motors for respectively driving the hour hand 4, the minute hand 5, and the seconds hand 6 independently of each other may be provided, a motor for driving the hour hand 4, and a motor for driving the minute hand 5 and the seconds hand 6 may be provided, or a motor for driving all of the hour hand 4, the minute hand 5, and the seconds hand 6 may be provided. Further, the electronic watch 1 need not necessarily include the seconds hand 6, and may be a two-hand watch configured by the hour hand 4 and the minute hand 5. Furthermore, the electronic watch 1 may be a watch that includes an analog display unit provided with the hour hand 4 and the minute hand 5, and a digital display unit that displays seconds information and the like.

Here, since the hour hand 4 and the minute hand 5 require a larger number of steps to rotate by one full rotation compared to the seconds hand 6, when the first control processing is performed with respect to the motor for driving the hour hand 4 and the minute hand 5, the hand position detection time at the times of the second and subsequent system resets can be effectively shortened. Particularly, when the hour hand 4 and the minute hand 5 are moved by the single motor in an interlocking manner, the effect of reducing the hand position detection time is high.

### SUMMARY

An electronic watch according to the present disclosure includes a hand, a driving mechanism configured to drive the hand, a hand position detection mechanism configured to detect that the hand is at a reference position, and a controller configured to, when a system reset is performed, perform first control processing of moving, by the driving mechanism, the hand in a first direction by a first number of steps, and subsequently perform second control processing of performing, by the hand position detection mechanism, a detection operation every time moving the hand in a second direction that is a direction opposite to the first direction.

According to the electronic watch according to the present disclosure, when the system reset is performed a plurality of times, a hand position detection time can be shortened at least at times of the second and subsequent system resets, that is, at times when the system reset is performed in a state in which each of the hands is at the reference position. Further, backlash of each of train wheels can be eliminated to the forward rotation side, and thus attachment accuracy of the hand can be improved.

In the electronic watch according to the present disclosure, after the system reset is performed, the controller moves the hand for polarity alignment, and subsequently, sequentially performs the first control processing and the second control processing.

According to the electronic watch according to the present disclosure, after the system reset, the controller initially moves the hand in the forward rotation direction to perform the polarity alignment, and thus the polarity alignment can be performed properly even in a model in which the polarity alignment needs to be performed by moving the hand in the forward rotation direction.

In the electronic watch according to the present disclosure, the movement of the hand in the first direction also serves as a movement of the hand for polarity alignment.

According to the electronic watch according to the present disclosure, when the hand is moved by a fixed number of steps in the first direction, the polarity alignment can be performed at the same time. Thus, hand movements for the polarity alignment can be omitted, and it is thus possible to reduce a number of hand movements and further shorten the hand position detection time.

In the electronic watch according to the present disclosure, the hand is a hand for which a maximum time required for hand position detection processing exceeds a threshold value.

With respect to the hand for which the maximum time required for the hand position detection processing exceeds the threshold value, by performing the first control processing and the second control processing, the hand position detection time can be shortened at least at the times of the second and subsequent system resets.

The electronic watch according to the present disclosure includes an hour hand and a minute hand, and in the electronic watch, the hand is at least one of the hour hand and the minute hand.

According to the electronic watch according to the present disclosure, since the hour hand and the minute hand require a number of steps to rotate by one full rotation, by performing the first control processing and the second control processing, the hand position detection time can be highly effectively shortened at least at the times of the second and subsequent system resets.

The electronic watch according to the present disclosure includes an hour hand and a minute hand, and in the electronic watch, the driving mechanism includes a single motor for driving the hour hand and the minute hand.

According to the electronic watch according to the present disclosure, when the hour hand and the minute hand are driven by the single motor in an interlocked manner, since the hour hand requires a number of steps to rotate by one full rotation, by performing the first control processing and the second control processing, the hand position detection time can be highly effectively shortened at least at the times of the second and subsequent system resets.

In a control method of an electronic watch according to the present disclosure, the electronic watch includes a hand, a driving mechanism configured to drive the hand, and a hand position detection mechanism configured to detect that the hand is at a reference position. The control method includes performing, when a system reset is performed, first control processing of moving, by the driving mechanism, the hand in a first direction by a first number of steps, and subsequently performing second control processing of performing, by the hand position detection mechanism, a detection operation every time moving the hand in a second direction that is a direction opposite to the first direction.

According to the control method of the electronic watch according to the present disclosure, when the system reset is performed a plurality of times, the hand position detection time can be shortened at least at times of the second and subsequent system resets, that is, at times when the system reset is performed in a state in which each of the hands is at the reference position. Further, backlash of each of train wheels can be eliminated to the forward rotation side, and thus attachment accuracy of the hand can be improved.

What is claimed is:

1. An electronic watch comprising:
a hand;
a driving mechanism configured to drive the hand;
a hand position detection mechanism configured to detect that the hand is at a reference position; and
a controller configured to, when a system reset is performed, perform first control processing of moving, by the driving mechanism, the hand in a first direction by a first number of steps, and subsequently perform second control processing of performing, by the hand position detection mechanism, a detection operation every time moving the hand in a second direction that is a direction opposite to the first direction.

2. The electronic watch according to claim 1, wherein
after the system reset is performed, the controller moves the hand for polarity alignment, and subsequently, sequentially performs the first control processing and the second control processing.

3. The electronic watch according to claim 1, wherein
the movement of the hand in the first direction also serves as a movement of the hand for polarity alignment.

4. The electronic watch according to claim 1, wherein
the hand is a hand for which a maximum time required for hand position detection processing exceeds a threshold value.

5. The electronic watch according to claim 2, wherein
the hand is a hand for which a maximum time required for hand position detection processing exceeds a threshold value.

6. The electronic watch according to claim 3, wherein
the hand is a hand for which a maximum time required for hand position detection processing exceeds a threshold value.

7. The electronic watch according to claim 4, comprising:
an hour hand and a minute hand, wherein
the hand is at least one of the hour hand and the minute hand.

8. The electronic watch according to claim 5, comprising:
an hour hand and a minute hand, wherein
the hand is at least one of the hour hand and the minute hand.

9. The electronic watch according to claim 6, comprising:
an hour hand and a minute hand, wherein
the hand is at least one of the hour hand and the minute hand.

10. The electronic watch according to claim 4, comprising:
an hour hand and a minute hand, wherein
the driving mechanism includes a single motor for driving the hour hand and the minute hand.

11. The electronic watch according to claim 5, comprising:
an hour hand and a minute hand, wherein
the driving mechanism includes a single motor for driving the hour hand and the minute hand.

12. The electronic watch according to claim 6, comprising:
an hour hand and a minute hand, wherein
the driving mechanism includes a single motor for driving the hour hand and the minute hand.

13. A control method of an electronic watch including a hand, a driving mechanism configured to drive the hand, and a hand position detection mechanism configured to detect that the hand is at a reference position, the control method comprising:
performing, when a system reset is performed, first control processing of moving, by the driving mechanism, the hand in a first direction by a first number of steps, and subsequently performing second control processing of performing, by the hand position detection mechanism, a detection operation every time moving the hand in a second direction that is a direction opposite to the first direction.
